(19) United States
(12) Patent Application Publication
(10) Pub. No.: US 2012/0217028 A1
(43) Pub. Date: Aug. 30, 2012

(54) ACTIVE ODORANT WARNING

(75) Inventors: Adam Chattaway, Windsor (GB); Robert Glaser, Stella, NC (US); Paul Rennie, Bracknell (GB); Josephine Gabrielle Gatsonides, Dunstable (GB)

(73) Assignee: KIDDE TECHNOLOGIES, INC., Wilson, NC (US)

(21) Appl. No.: 13/033,665

(22) Filed: Feb. 24, 2011

(51) Int. Cl. A62C 3/08

(52) U.S. Cl. 169/62

(57) ABSTRACT

A fire suppression and warning system for an aircraft includes an inert gas delivery system, an inert gas indicator, an on-ground indicator, and a warning device. The inert gas delivery system delivers an inert gas output to an enclosed space on the aircraft. The inert gas indicator signals that the inert gas delivery system has delivered the inert gas output to the enclosed space. The on-ground indicator signals that the aircraft is located on the ground. The warning device actively warns that the inert gas output is present in the enclosed space in response to a signal from the inert gas indicator and a signal from the on-ground indicator.

### BACKGROUND

The present disclosure relates to fire suppression systems and more particularly to the use of odorants in fire suppression systems.

Fire suppression systems are often included in aircraft, buildings, or industrial structures having contained areas. A variety of fire suppression systems using different extinguishing agents and methods are known. Since fire propagation requires oxygen, some fire suppression systems use inert gases to dilute the supply of oxygen and suppress the fire.

### SUMMARY

A fire suppression and warning system for an aircraft is disclosed. The fire suppression and warning system includes an inert gas delivery system, an inert gas indicator, an on-ground indicator, and a warning device. The inert gas delivery system delivers an inert gas output to an enclosed space on the aircraft. The inert gas indicator signals that the inert gas delivery system has delivered the inert gas output to the enclosed space. The on-ground indicator signals that the aircraft is located on the ground. The warning device actively warns that the inert gas output is present in the enclosed space in response to a signal from the inert gas indicator and a signal from the on-ground indicator.

A method for warning of a presence of inert gas in an enclosed space on an aircraft is also disclosed. The method includes the steps of detecting the presence of the inert gas, detecting that the aircraft is located on ground, and activating a warning that the inert gas is present in the enclosed space and the aircraft is located on ground.

In one embodiment, the warning device for the fire suppression system includes an odorant storage container and an odorant activation mechanism. The odorant storage container stores the odorant and the odorant activation mechanism initiates release of the odorant from the odorant storage container to the enclosed space. The odorant activation mechanism initiates release of the odorant when inert gas is present in the enclosed space and the aircraft is located on ground.

### BRIEF DESCRIPTION OF THE DRAWINGS

FIG. 1 is a perspective view of an airplane having a fire suppression system in accordance with the present disclosure.

FIG. 2 is a schematic of the fire suppression system including a warning system.

FIG. 3 is a schematic depicting activation of an odorant delivery device.

FIG. 4 is a diagram of a method for warning of a presence of inert gas in an enclosed space of an aircraft in accordance with the present disclosure.

### DETAILED DESCRIPTION

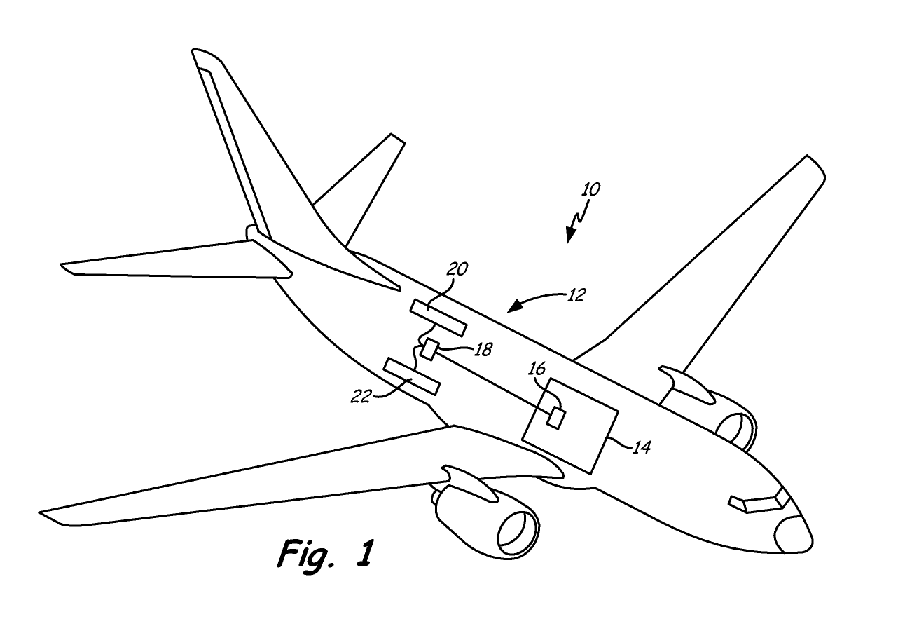

FIG. 1 is a perspective view of airplane 10 as an example aircraft having a fire suppression system 12 for enclosed space 14. Fire suppression system 12 includes fire detector 16, controller 18, high rate discharge (HRD) delivery system 20, and low rate discharge (LRD) delivery system 22. In case of a fire event within enclosed space 14 (such as a cargo bay) of aircraft 10, fire suppression system 12 is activated.

Fire detector 16 is located with enclosed space 14, while controller and HRD delivery system 20 and LRD delivery system 22 are located outside of enclosed space 14. Fire detector 16 senses the fire event within enclosed space 14 from a presence of smoke, heat, or other change in the local environment. Fire detector 16 sends a signal to controller 18 that the fire event has been detected and fire suppression system 12 should be activated. Controller 18 sends a first signal to HRD delivery system 20 requesting a high rate of discharge of a fire suppression agent for immediate fire suppression. Controller 18 sends a second, subsequent signal to LRD delivery system 22 requesting a low rate of discharge of a fire suppression agent for continuing fire suppression. HRD delivery system 20 and LRD delivery system 22 are configured to work together as unified fire suppression system 12 to extinguish and/or suppress fire events within enclosed space 14 of aircraft 10.

Fire propagation requires oxygen. Fire suppression system 12 is configured to reduce oxygen by introducing inert gas to enclosed space 14. HRD delivery system 20 and LRD delivery system 22 both flow inert gases such as nitrogen, helium, argon or the like into enclosed space 14 to suppress the propagation of fire. HRD delivery system 20 is a “first line defense” because it releases a first inert gas output at a high discharge rate to enclosed space 14 in response to the initial signal from controller 18. The purpose of HRD delivery system 20 is an immediate reduction of oxygen and control over fire propagation. LRD delivery system 22 is a “second line defense” because it releases a second inert gas output at a low discharge rate to enclosed space 14 in response to a second signal from controller 18. The purpose of LRD delivery system 22 is continuing the low oxygen environment established by HRD delivery system 20, thereby exerting lasting control over fire propagation. Use of fire suppression system 12 will result in accumulation of inert gases within enclosed space 14, which pose a danger to human health. A worker entering enclosed space 14 may not be aware of the presence of inert gases and/or the lack of oxygen and suffer deleterious health effects. A warning system is needed to warn humans of the presence of inert gases and/or the lack of oxygen in enclosed space 14 after use of fire suppression system 12.

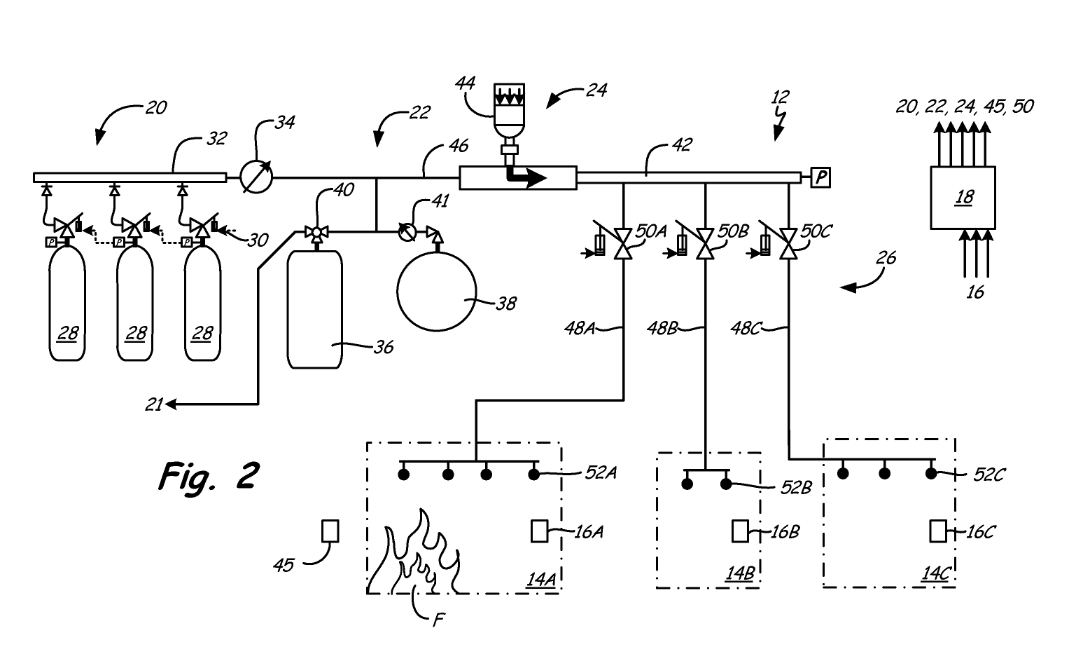

FIG. 2 is a schematic of fire suppression system 12 including HRD delivery system 20, LRD delivery system 22, and warning system 24. Depicted in FIG. 2 are enclosed spaces 14A, 14B, 14C, fire detectors 16A, 16B, 16C, HRD delivery system 20, fuel tanks 21, LRD delivery system 22, warning system 24, and distribution ducting 26. HRD delivery system 20 further includes HRD pressure vessels 28, HRD discharge valves 30, HRD collector 32, and HRD regulator valve 34. LRD delivery system 22 further includes LRD nitrogen enriched air (NEA) source 36, LRD pressure vessel 38, LRD selector valve 40, LRD regulator valve 41, and LRD distributor 42. In the depicted embodiment, warning system 24 includes odorant delivery device 44 and audio/visual device 45. Distribution ducting 26 includes main conduit 46, branch conduits 48A, 48B, 48C, diverter valves 50A, 50B, 50C, and nozzles 52A, 52B, 52C. HRD delivery system 20 and LRD delivery system 22 release inert gases to suppress fire event F in enclosed space 14A, and warning system 24 and/or audio/visual device 45 warns humans that inert gases are present in enclosed space 14A.

HRD delivery system 20 includes a plurality of HRD pressure vessels 28, each containing a volume of inert gas at a high pressure. Each HRD pressure vessel 28 has an associated HRD discharge valve 30 and a conduit connecting the HRD pressure vessel 28 to HRD collector 32. A signal from controller 18 indicates the occurrence of fire event F in enclosed space 14A and causes discharge valves 30 to release gas from HRD pressure vessel 28 into HRD collector 32. Inert gas is collected in HRD collector 32 and released by HRD regulator valve 34 as a first inert gas output that flows through conduit 46 and through distribution ducting 26 to enclosed spaced 14A. The first inert gas output is provided to enclosed space 14A at a high rate of discharge, but only for a short duration. The HRD delivery system 20 is intended to provide quick, strong burst of inert gas for immediate suppression of fire event F.

LRD delivery system 22 is located on a separate branch from HRD delivery system 20. In the depicted embodiment LRD delivery system 22 includes both LRD NEA source 36 and LRD pressure vessel 38. In an alternative embodiment, LRD NEA source 36 or LRD pressure vessel 38 are present in LRD delivery system 22. LRD NEA source 36 contains nitrogen enriched air. Under normal conditions, LRD NEA source 36 is likely to be running continuously and NEA is diverted by selector valve 40 to areas such as fuel tanks 21 which require continuous inerting. NEA from LRD NEA source 36 can be redirected by selector valve 40 toward LRD distribution ducting 42 for use in controlling fire event F. LRD pressure vessel 38 contains a volume of inert gas under pressure. After HRD delivery system 20 has released the first inert gas output to enclosed space 14A, controller 18 causes LRD selector valve 40 to release NEA from LRD NEA source 36 and/or LRD regulator valve 41 to release inert gas from LRD pressure vessel 38 as a second inert gas output. The second inert gas output flows through conduit 46 to LRD distributor 42, and through distribution ducting 26 to enclosed space 14A. This second inert gas output is provided to enclosed space 14A at a low rate of discharge and for a long duration. The LRD delivery system 22 is intended to provide a slow, lasting flow of inert gas for continued suppression of fire event F.

HRD delivery system 22 and LRD delivery system 22 branches merge at main conduit 46 before odorant delivery device 44. For this circumstance, odorant delivery device 44 is capable of withstanding the flow and pressure of HRD delivery system 22. In an alternative embodiment, odorant delivery device 44 is included on LRD delivery system 22 branch upstream of a location where LRD delivery system 22 joins HRD delivery system 20 at LRD distribution ducting 42.

Warning system 24 includes two means for warning humans of the presence of inert gas in enclosed space 14A: odorant delivery device 44 and audio/visual device 45. In other embodiments warning device 24 includes only one of odorant delivery device 44 and/or audio/visual devices 45. In the depicted embodiment, odorant delivery device 44 is located downstream of LRD delivery system 22 on main conduit 46. In alternative embodiments, odorant delivery device 44 is located on branch conduits 48A, 48B, 48C and/or adjacent nozzles 52A, 52B, 52C for each enclosed space 14A, 14B, 14C, respectively. Controller 18 activates odorant delivery device 44 to release an odorant to enclosed space 14A and provide an odiferous warning of the presence of inert gas and/or lack of oxygen. Audio/visual devices 45 is located adjacent enclosed spaces 14A, 14B, and 14C and may include a digital display, color, light, and/or siren. Controller 18 activates audio/visual devices 45 to provide an auditory and/or visual warning of the presence of inert gas and/or lack of oxygen in enclosed space 14A.

FIG. 2 depicts three enclosed spaces 14A, 14B, and 14C having fire detectors 16A, 16B, 16C, respectively. Enclosed spaces 14A, 14B, and 14C represent any enclosed space on aircraft 10 having fire suppression system 12 (e.g. cargo bay or equipment space). Distribution ducting 26 provides a fluid connection between HRD delivery system 20, LRD delivery system 22, warning system 24 and enclosed spaces 14A, 14B, 14C. HRD delivery system 20 and LRD delivery system 22 are on separate branches and odorant delivery device 44 is positioned downstream of HRD delivery system 20 and LRD delivery system 22 on main conduit 46. Main conduit 46 extends from at least HRD collector 32 to LRD distributor 42, at which point main conduit 46 splits into branch conduits 48A, 48B, 48C to each of enclosed spaces 14A, 14B, 14C, respectively. Each branch conduct 48A, 48B, 48C includes diverter valve 50A, 50B, 50C and terminates in nozzles 52A, 52B, 52C, respectively. Controller 18 opens diverter valve 50A, 50B, 50C on whichever branch conduit 48A, 48B, 48C is associated with the enclosed space 14A, 14B, 14C experiencing the fire event. In the depicted embodiment, fire event F is detected by fire detector 16A in enclosed space 14A, which signals controller 18 to begin fire suppression system 12. Diverter valve 50A on branch conduit 48A will move to the open position while diverter valves 50B and 50C on branch conduits 48B and 48C will remain closed. The first inert gas output from HRD delivery system 20, the second inert gas output from LRD delivery system 22, and the odorant from odorant delivery device 44 will travel through opened diverter valve 50A on branch conduit 48A, and out of nozzles 52A in enclosed space 14A.

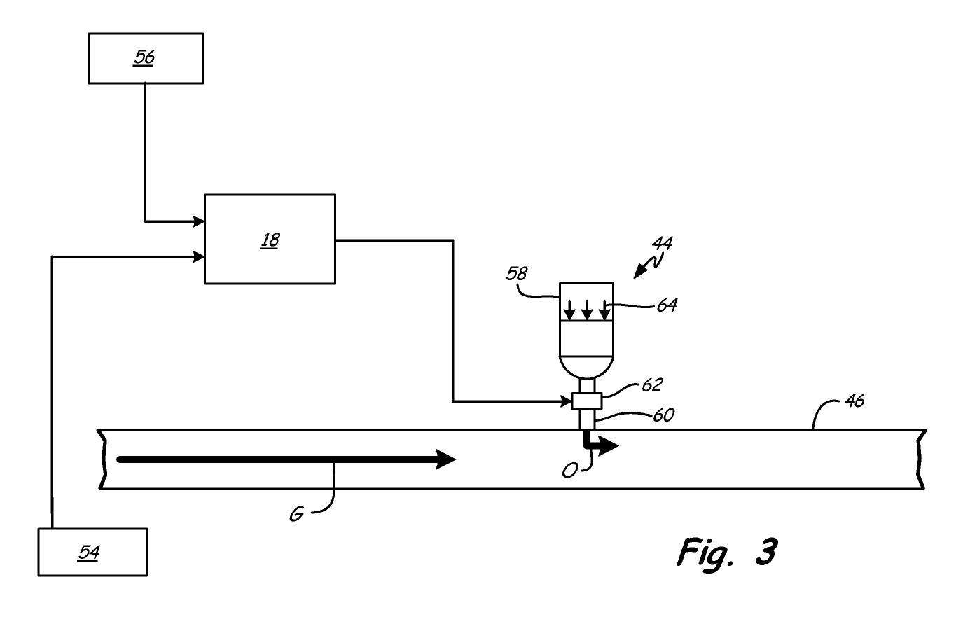

FIG. 3 is a schematic depicting activation of odorant delivery device 44. Shown in FIG. 3 are controller 18, odorant delivery device 44, main conduit 46 containing inert gas G and odorant O, inert gas indicator 54, and on-ground indicator 56. Odorant delivery device 44 includes odorant storage container 58, connecting conduit 60, odorant activation mechanism 62, and odorant discharge agent 64. After receiving signals from inert gas indicator 54 and on-ground indicator, controller 18 activates odorant delivery device 44.

In the depicted embodiment, warning system 24 includes odorant delivery device 44 fluidly connected to an outer wall of main conduit 46. In alternative embodiments, odorant delivery device 44 is fluidly connected to, or positioned within, nozzles 52. Inert gas indicator 54 and on-ground indicator 56 are electrically connected to controller 18, which is electrically connected to odorant delivery device 44. Inert gas indicator 54 includes at least one means for determining that HRD delivery system 20 and/or LRD delivery system 22 has released inert gas into enclosed space 14A. For example, inert gas indicator 54 can monitor activation of HRD delivery system 20 and/or LRD delivery system 22, presence of inert gas within one or more storage containers (e.g. HRD pressure vessels 28, LRD NEA source 36, or LRD pressure vessel 38), pressure change within enclosed space 14A, and/or reduced presence of oxygen within enclosed space 14A. On-ground indicator 56 includes at least one means for determining that aircraft 10 has landed or is located on the ground. For example, on-ground indicator 56 can monitor a door latch (e.g. cargo bay door latch), activation of landing gear, presence of aircraft weight on wheels, and/or a change in pressure within aircraft 10. Note odorant delivery device 44 is not capable of inadvertent activation by HRD flow.

Odorant delivery device 44 includes odorant storage container 58 and is attached to main conduit 46 by connecting conduit 60. In an alternative embodiment, odorant storage container 58 is attached to nozzles 52 by connecting conduit 60. Odorant activation mechanism 62 is located on connecting conduit 60 between odorant storage container 58 and main conduit 46. Odorant activation mechanism 62 can include any means for activating odorant delivery device 44 such as a solid propellant gas generator and diaphragm, a cartridge valve, a solenoid valve, a protractor or flapper valve. Odorant discharge agent 64 is located within odorant storage container 58 along with odorant O. Odorant discharge agent 64 can include any means for pushing odorant O out of storage container 58 such as a pressurized gas (e.g. nitrogen), a solid propellant, a spring-loaded or pneumatically loaded storage container 58. Odorant activation mechanism 62 triggers odorant discharge agent 64 to push odorant O out of odorant storage container 58.

As described with respect to FIG. 2, fire detector 16A detects fire event F in enclosed space 14A and sends a signal to controller 18. Controller 18 activates fire suppression system 12 including HRD delivery system 20 and LRD delivery system 20. Inert gas indicator 54 detects the presence of inert gas from HRD delivery system 20 and/or LRD delivery system 20 and sends a signal to controller 18. On-ground indicator 56 detects that the aircraft is located on the ground and sends a signal to controller. Once in receipt of both a signal from inert gas indicator 54 and a signal from on-ground indicator 56, controller 18 sends a signal to odorant activation mechanism 62 in order to activate odorant delivery device 44. Odorant activation mechanism 62 includes an on/off valve and can additionally include a means for meting odorant O as it exits odorant storage container 58. Once the on/off portion of odorant activation mechanism 62 is actuated, odorant discharge agent 64 pushes odorant 0 out of storage container 58, through connecting conduit 60 and into main conduit 46 for delivery to enclosed space 14A. In alternative embodiments, odorant delivery device 44 is located at nozzles 52 within enclosed space 14A and therefore, odorant discharge agent 64 pushes odorant out of storage container 58, through connecting conduit 60, and out of nozzles 52 into enclosed space 14A. Regardless of the particular activation mechanism 62 or discharge agent 56, odorant O is released to enclosed space 14A to warn humans of the presence of inert gas and/or lack of oxygen.

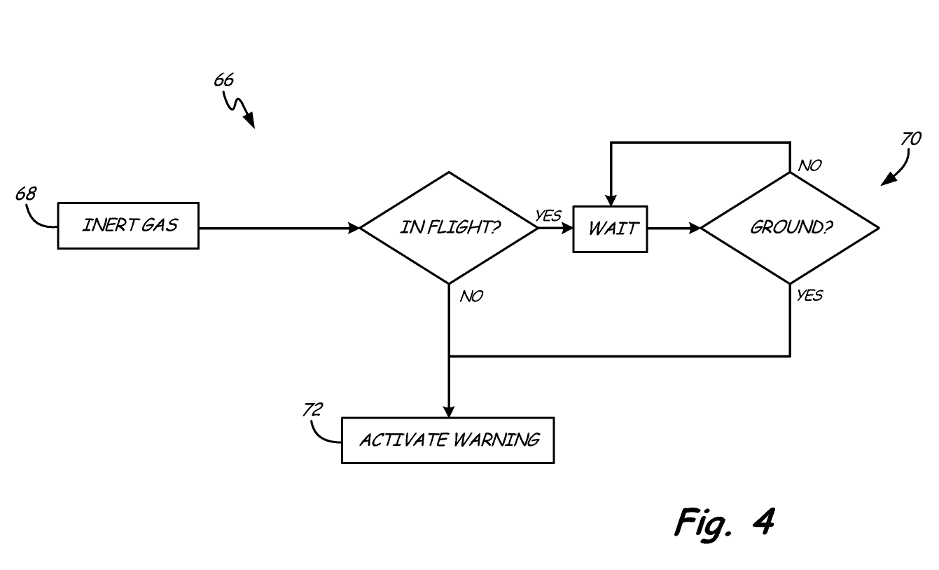

FIG. 4 shows method 66 for warning of a presence of inert gas in enclosed space 14A of aircraft 10. Method 66 includes detecting the presence of the inert gas (step 68), detecting that the airplane is located on ground (step 70), and activating a warning that the inert gas is present in the enclosed space (step 72). Method 66 is an active warning system that can protect workers from hazardous health conditions caused by use of inert gases in fire suppression system 12.

There are a number of situations where fire suppression system 12 may flow inert gases to enclosed space 14A, but fail to adequately warn humans of the presence of inert gas. Passive warning systems may be ineffective or diluted by the time aircraft 10 has landed and the warning is needed. Method 66 provides an active or deliberate warning system 24 that is more or less independent of HRD delivery system 20 and LRD delivery system 22. Method 66 requires the two signal inputs to controller 18 in order to trigger warning device 24.

Method 66 first includes detecting the presence of the inert gas (step 68). Step 68 can be performed by inert gas indicator 54 and is configured to inform controller 18 that fire suppression system 12 has been activated and that inert gas is flowing to enclosed space 14A (i.e. activation of warning system 24 is needed). Second, method 66 includes detecting that the aircraft is located on the ground (step 70). Step 70 can be performed by on-ground indicator 56 and is configured to inform controller (18) that it is an appropriate time to trigger warning system 24. Since it is unlikely that a worker would enter enclosed space 14A during flight, activation of warning system is reserved for once aircraft has landed. If aircraft 10 is in flight, controller 18 waits and if aircraft is on the ground (step 70), then method 66 can proceed. Third, once controller 18 is in receipt of both a signal from inert gas indicator 54 that inert gas is detected (step 68) and a signal from on-ground indicator 56 that aircraft 10 is on the ground (step 70), then warning system 24 is activated (step 72). Activation of warning system 24 (step 72) can include one or more sensory warnings (i.e. olfactory, auditory, visual). For example, warning system 24 can include discharge of odorant O to enclosed space 14A (e.g. odorant delivery device 44), colored and/or flashing lights, illuminated displays, and/or auditory alarms. Method 66 provides reliable logic for determining if and when warning system 24 is needed to warn workers of the presence of inert gas and/or lack of oxygen in enclosed space 14A.

Although the present invention has been described with reference to preferred embodiments, workers skilled in the art will recognize that changes may be made in form and detail without departing from the spirit and scope of the invention.

1. A fire suppression and warning system for an aircraft, the system comprising:
an inert gas delivery system for delivering an inert gas output to an enclosed space on the aircraft;
an inert gas indicator for signaling that the inert gas delivery system delivered the inert gas output to the enclosed space;
an on-ground indicator for signaling that the aircraft is located on the ground; and
a warning device for warning that the inert gas output is present in the enclosed space, the warning device being activated in response to a signal from the inert gas indicator and a signal from the on-ground indicator.

2. The system of claim 1, wherein the inert gas indicator monitors activation of the inert gas delivery system, presence of inert gas within a storage container, or concentration of oxygen within the enclosed space.

3. The system of claim 1, wherein the on-ground indicator monitors a door to the enclosed space, activation of a landing gear, presence of weight on wheels, or a change in pressure within the aircraft.

4. The system of claim 1, wherein the warning device produces at least one warning output configured to alert at least one human sensory system.

5. The system of claim 4, wherein the warning device includes at least one of an odorant, digital display, light, and alarm.

6. The system of claim 1, wherein the warning device includes an odorant delivery system comprising:
an odorant storage container for storing odorant;
an odorant activation mechanism for activating the odorant delivery system; and
an odorant discharge agent for discharging odorant from the odorant storage container to the enclosed space.

7. The system of claim 6, wherein the odorant activation mechanism includes a cartridge valve, a solenoid valve, or a flapper valve.

8. The system of claim 6, wherein the odorant discharge agent includes a gas propellant, a solid propellant, or a spring-loaded container.

9. A method for warning of a presence of inert gas in an enclosed space on an aircraft, the method comprising:
detecting the presence of the inert gas;
detecting that the aircraft is located on ground; and
activating a warning that the inert gas is present in the enclosed space when the aircraft is located on ground.

10. The method of claim 9, wherein detecting the presence of inert gas includes monitoring activation of an inert gas delivery system, monitoring presence of inert gas within a storage container, or monitoring presence of oxygen within the enclosed space.

11. The system of claim 9, wherein detecting that the aircraft is located on the ground includes monitoring a door to the enclosed space, monitoring activation of a landing gear, monitoring presence of weight on wheels, or monitoring a change in pressure within the aircraft.

12. The system of claim 9, wherein activating the warning that the inert gas is present in the enclosed space includes releasing an odorant, activating a digital display, turning on a light, or emitting a siren.

13. A fire suppression and warning system for an aircraft, the system comprising:
an enclosed space located on the aircraft;
an inert gas delivery system for delivering inert gas to the enclosed space;
an odorant storage container for storing an odorant; and
an odorant activation mechanism for initiating release of the odorant from the odorant storage container to the enclosed space, the odorant activation mechanism initiating release of the odorant when inert gas is present in the enclosed space and the aircraft is located on ground.

14. The system of claim 13, further comprising:
a distribution network fluidly connecting the inert gas delivery system to the enclosed space.

15. The system of claim 14, wherein the odorant storage container is fluidly connected to the distribution network.

16. The system of claim 13, wherein the odorant activation mechanism includes a cartridge valve, a solenoid valve, or a flapper valve.

17. The system of claim 13, further comprising:
an odorant discharge agent for discharging odorant from the odorant storage container to the enclosed space.

18. The system of claim 17, wherein the odorant discharge agent includes a gas propellant, a solid propellant, or a spring-loaded container.
